(19) United States
(12) Patent Application Publication
(10) Pub. No.: US 2015/0149629 A1
(43) Pub. Date: May 28, 2015

(54) USER ONLINE STATE QUERYING METHOD AND APPARATUS

(71) Applicant: HUAWEI TECHNOLOGIES CO., LTD., Shenzhen (CN)

(72) Inventors: Weibing Zhang, Nanjing (CN); Qingyuan Bai, Nanjing (CN)

(73) Assignee: HUAWEI TECHNOLOGIES CO., LTD., Shenzhen (CN)

(21) Appl. No.: 14/604,963

(22) Filed: Jan. 26, 2015

Related U.S. Application Data
(63) Continuation of application No. PCT/CN2012/079298, filed on Jul. 27, 2012.

(51) Int. Cl. H04L 29/08

(52) U.S. Cl. CPC H04L 67/16
USPC 709/225

(57) ABSTRACT

A user state querying method is provided. The method includes: saving an association between a user identity of a user in a first service system and a user identity of the user in a second service system, where the first service system and the second service system are different service systems; obtaining an activation state of the user in the first service system and the second service system; receiving a state query request from the first service system; and sending the activation state of the user in the second service system to the first service system according to the association and a user identity included in the state query request. By using the present invention, a query of a user state between different systems can be implemented.

### CROSS-REFERENCE TO RELATED APPLICATIONS

This application is a continuation of International Application No. PCT/CN2012/079298, filed on Jul. 27,2012, which is hereby incorporated by reference in its entirety.

### TECHNICAL FIELD

Embodiments of the present invention relate to the communications field, and in particular, to a user state querying method and apparatus.

### BACKGROUND

With construction of a 3G network and upgrade of mobile phone terminals, content-centric value-added data services (for example, video on demand and download) have quickly entered people's lives. At the same time, with constant development and increasing popularity of Internet Protocol Television (IPTV) IP television, a user can choose a most appropriate terminal device (for example, a mobile phone, a PC, or a set-top box) to use various data services in different scenarios. Normally, different terminal device types correspond to different user accounts. For example, a mobile phone terminal uses a mobile number, a PC normally uses an Email account or various instant messaging numbers, and an IPTV set-top box (STB, set top box) uses an STB user account. In the prior art, a cross-system query cannot be performed between systems having different screens, and a system can only query a state of a user within the system. That is, the user in one system cannot learn whether another user logs in or is activated in another system.

### SUMMARY

Embodiments of the present invention provide a user state querying method and apparatus, to solve a technical problem that an activation state of a user in a different system cannot be queried across systems.

An embodiment of the present invention provides a user state querying method, including:

saving an association between a user identity of a user in a first service system and a user identity of the user in a second service system, where the first service system and the second service system are different service systems;

obtaining an activation state of the user in the first service system and the second service system;

receiving a state query request from the first service system; and

sending the activation state of the user in the second service system to the first service system according to the association and a user identity included in the state query request.

Preferably, the user identity included in the state query request is the user identity of the user in the first service system.

Preferably, the first service system and the second service system are any two of the following service systems: an Internet system, a cable television system, and a mobile communications system.

An embodiment of the present invention further provides a user state querying method, where the method includes:

receiving, by a first service system, a state query request, where the state query request is a request for querying an activation state of a user in a second service system, and the state query request includes a user identity of the user in the first service system or the second service system, where the first service system and the second service system are different service systems;

sending the state query request which includes the user identity to a user state management apparatus, where the user state management apparatus stores an association between the user identity of the user in the first service system and the user identity of the user in the second service system, and the activation state of the user in the first service system and the second service system; and

receiving the activation state, which is sent by the user state management apparatus, of the user in the second service system, where the activation state is obtained by the user state management apparatus according to the stored association and the user identity in the state query request.

Preferably, the method further includes:

if the user is in an activated state in the second service system, sending, by the first service system, a message to the user in the activated state in the second service system.

Preferably, the user identity included in the state query request is the user identity of the user in the first service system.

Preferably, the sending, by the first service system, a message to the user in the activated state in the second service system includes that: the message is service recommendation information, where the recommendation information includes a URL link, so that an activated user in the second service system, after receiving the information, can directly trigger the URL link to access related recommended content.

Preferably, the first service system and the second service system are any two of the following service systems: an Internet system, a cable television system, and a mobile communications system.

An embodiment of the present invention further provides a user state management apparatus, where the apparatus includes a storing module, an obtaining module, a receiving module, and a sending module, where

the storing module is configured to save an association between a user identity of a user in a first service system and a user identity of the user in a second service system, where the first service system and the second service system are different service systems;

the obtaining module is configured to obtain an activation state of the user in the first service system and the second service system;

the receiving module is configured to receive a state query request from the first service system; and

the sending module is configured to send the activation state of the user in the second service system to the first service system according to the association and a user identity included in the state query request.

Preferably, the first service system and the second service system are any two of the following service systems: an Internet system, a cable television system, and a mobile communications system.

According to the foregoing technical solutions of the embodiments of the present invention, a user state management apparatus is set to uniformly save and manage an activation state of a user in various service systems, to implement a query of the activation state of the user across service systems.

### BRIEF DESCRIPTION OF DRAWINGS

To illustrate the technical solutions in the embodiments of the present invention more clearly, the following briefly introduces the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a flowchart of a method according to an embodiment of the present invention;

FIG. 2 is a schematic diagram of a user identity association between service systems according to an embodiment of the present invention;

FIG. 2.1 is another schematic diagram of a user identity association between service systems according to an embodiment of the present invention;

FIG. 3 is a schematic flowchart for registering a new account according to an embodiment of the present invention;

FIG. 4 is a flowchart for changing an activation state of a user according to an embodiment of the present invention;

FIG. 5 is a flowchart for querying an activation state of a user in various service systems according to an embodiment of the present invention;

FIG. 6 is a flowchart of a method for implementing recommendation of a service to a friend according to an embodiment of the present invention;

FIG. 7 is a flowchart of intelligent information routing across service systems according to an embodiment of the present invention;

FIG. 8 is a schematic structural diagram of a user state management apparatus according to an embodiment of the present invention; and

FIG. 9 is a schematic structural diagram of another user state management apparatus according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

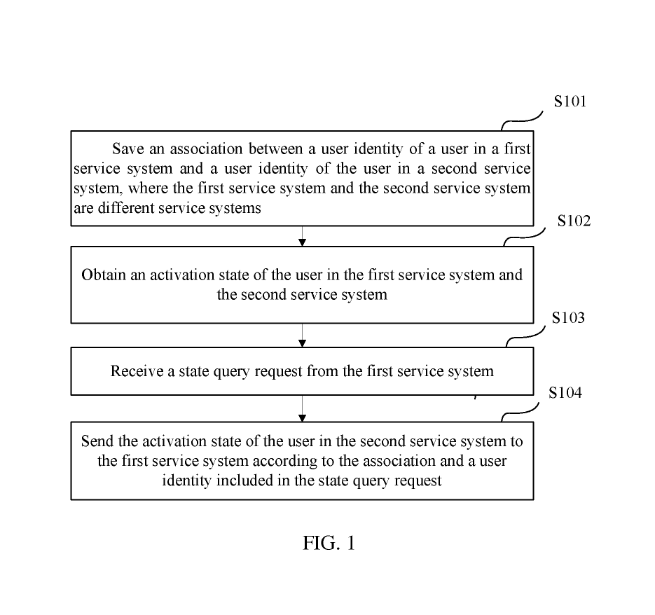

As shown in FIG. 1, an embodiment of the present invention provides a user state querying method, including:

S101. Save an association between a user identity of a user in a first service system and a user identity of the user in a second service system, where the first service system and the second service system are different service systems.

It may be understood by a person skilled in the art that the service system included in this embodiment of the present invention may not be limited to two service systems, and an association between user identities in three or more different service systems may be set according to actual requirements.

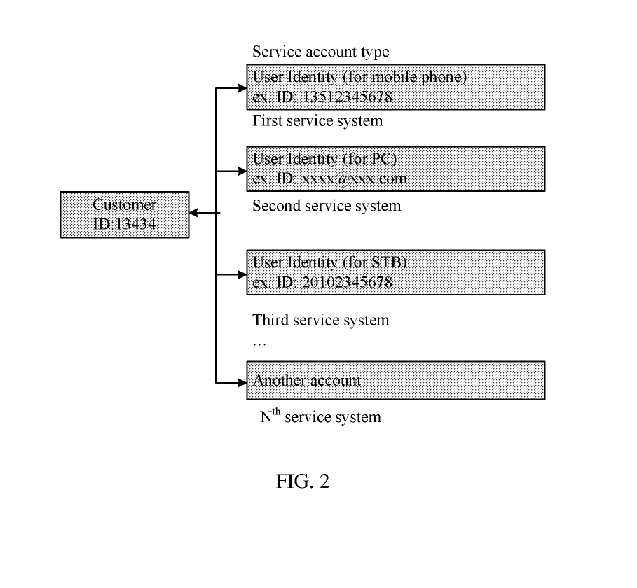

One manner for setting an association between user identities of a user in various service systems is illustrated in FIG. 2: Set a common customer ID, that is, Customer ID, for example, 13434, for the user; and then, associate user identities (User Identity) in the service systems with the common Customer ID to form a mapping relationship which is stored in a user state management apparatus. As shown in FIG. 2, a first service system is a mobile communications system, where a corresponding user terminal is a mobile phone whose ID is 13512345678; a second service system is an Internet system where a corresponding user terminal is a user personal computer whose ID is an ID XXXX@XXX.COM of a type of instant messaging software; and a third service system is a cable television system where a corresponding user terminal is a user set-top box whose ID is a terminal number ID 20102345678 of the set-top box STB. Certainly, this embodiment of the present invention may also be correspondingly extended to other service systems of the user, where the service systems are associated through correspondence to the uniform Customer ID.

One user may further correspondingly have multiple different accounts in one service system. For example, when the service system is the Internet system and the corresponding user terminal is the user personal computer PC, the user may have a QQ (an instant communication application) account, a microblog account, a WeChat account, and the like on the PC as long as the user can be uniquely identified and the mapping to the uniform Customer ID can be established. Similarly, referring to FIG. 2.1, regarding a same IPTV user ID, because the user may possibly use different set-top boxes, the user ID may also correspond to an activation state or online state of different set-top boxes.

Certainly, an association may be directly established between user identities in various service systems. As shown in the following Table 1, by querying the table, an activation state of the user in another service system can be queried by using an ID in one service system. This embodiment of the present invention imposes no limitations to a specific associating manner.

TABLE 1

| System | Terminal | ID | State |
|---|---|---|---|
| Mobile | Mobile | 13512345678 | Power-on |
| communi- | phone | | (or roaming, |
| cations | | | power-off, |
| system | | | or the like) |
| Internet system | PC | XXXX@XXX.COM | Online |
| Cable television | Set-top | 20102345678 | Power-on |
| system | box STB | | |

S102. Obtain an activation state of the user in the first service system and the second service system.

The activation state described in this embodiment of the present invention mainly includes a state whether the user is online, and also includes a state whether the user has logged in to a system, or whether a mobile phone of the user is powered off, roaming, or within a service area, or the like.

In this embodiment of the present invention, a uniform user state management apparatus is set, where the state management apparatus can obtain the activation state of the user in various service systems in real time or in a timely manner. A specific obtaining manner may be that, after the user logs in to or logs out of each service system, the activation state of the user in the service system is refreshed instantly to the user state management apparatus. For example, when the user logs in to a service system (for example, logs in to a WAP portal by using a mobile phone, logs in to a WEB portal by using a PC, or turns on an IPTV television set), the corresponding service system sends, after local account authentication is successful, a request for saving or changing the user's activation state to the user state management apparatus. In a case in which the user logs in to the service system, the user state management apparatus records an account state of the user corresponding to the service system (type) as “online” or “activated”. A procedure for logging out of the service system by the user is similar to the login procedure.

In addition, for some service systems (for example, a WEB system), logout by the user may not directly trigger sending of a real-time notice to the user state management apparatus to notify that the user goes offline or has logged out. In this case, a timeout detection function may be set in the service system or the user state management apparatus, where the service system may, when determining that the login time of the user times out, send a user logout or offline request to the user state management apparatus. In addition, the user state management apparatus may also periodically receive an online notice of the user in the service system; and if the online notice is not received when the online time times out, it may also be determined that the user goes offline.

S103. Receive a state query request from the first service system.

The state query request from the first service system may be a state query request sent by one user through the first service system for querying the activation state or online state of another user in all service systems, so as to determine, according to an activation condition of the other user in the service systems, a most efficient manner for communicating with the other user. For example, a message is sent only to a service system in which the other user is online, so as to ensure that the other user can receive the message in a timely manner.

S104. Send the activation state of the user in the second service system to the first service system according to the association and the user identity included in the state query request.

Because the association between the user identity of the user in the first service system and the user identity of the user in the second service system (or more service systems) is set and stored in the user state management apparatus, and the activation state of the user in each service system is also obtained, the user state management apparatus may query and obtain the activation state of the user in another service system (for example, the second service system) according to the user identity carried in the state query request. In this case, the user identity carried in the state query request is normally the user identity in the first service system. Certainly, the user identity may also be the user identity in the second service system (or another service system).

It may be understood by a person skilled in the art that this embodiment is not limited to two service systems, and the user state management apparatus may send the activation state of the user in three or more service systems to a state query requesting party in the first service system.

By using the method in the embodiment of the present invention, a cross-system query of an activation state of a user may be implemented between different service systems, thereby improving user experience.

The following describes related steps of a method for viewing a user online state according to an embodiment of the present invention with reference to specific service procedures.

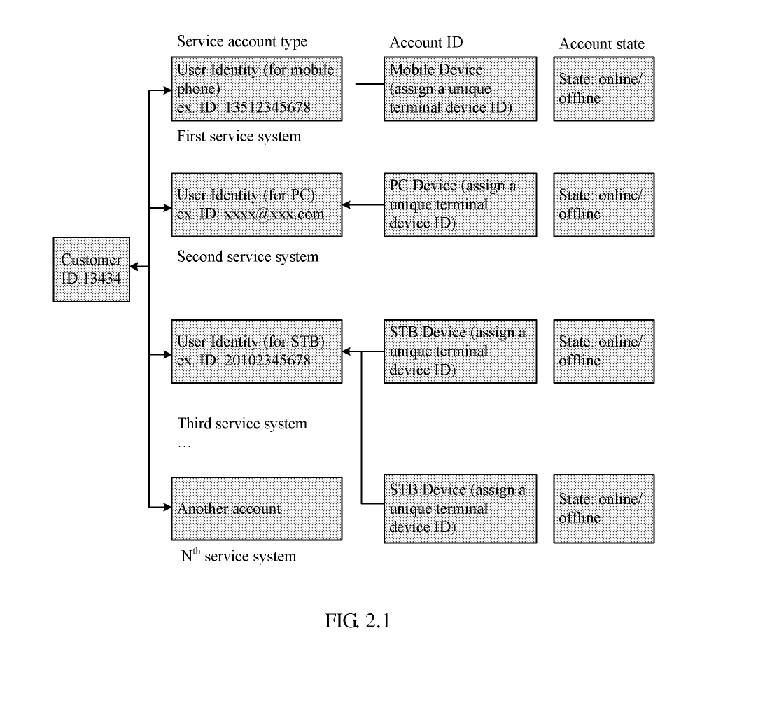

Refer to FIG. 3, which is a procedure for registering a new account according to an embodiment of the present invention.

In a case in which a common Customer ID is set for a user to implement an association between user identities of the user in multiple service systems, this embodiment of the present invention provides the following procedure for registering a new account, that is, the common Customer ID. Various external service systems may separately register user identities, that is, user IDs, in the service systems with a user state management apparatus by using a registration interface. Refer to FIG. 3 for the specific registration procedure, which may include the following steps:

Step 301: The user initiates a registration by entering a mobile number, a PC account, an STB account, or the like.

Steps 302 and 303: The user initiates the registration with the user state management apparatus by using a terminal device and the current service system in which the user is located.

Step 304: The user state management apparatus performs registration processing, which is specifically as follows:

The user state management apparatus performs the following processing after receiving a request from the registration interface:

1. determine whether an account type (for example, a service system type) and the account (for example, a user identity) in the current registration exist; if they do not exist, add one Customer record to a data model, and add one service account and account type record under the Customer record, where each Customer record corresponds to one unique common Customer ID;

2. if an account is queried according to the related account type and account, and verification is successful according to security check information, add one service account under the same Customer record; and

3. if an account is queried according to the account type and account, return a failure indicating “the account already exists”.

After the registration processing is complete, the user state management apparatus returns a user registration result, and the service system presents the registration result to the user.

By using the foregoing registration procedure according to this embodiment of the present invention, a user can complete an association between user identities thereof in various service systems. In the embodiment, a common Customer ID is registered in a user state management apparatus to associate the user identities in the various service systems.

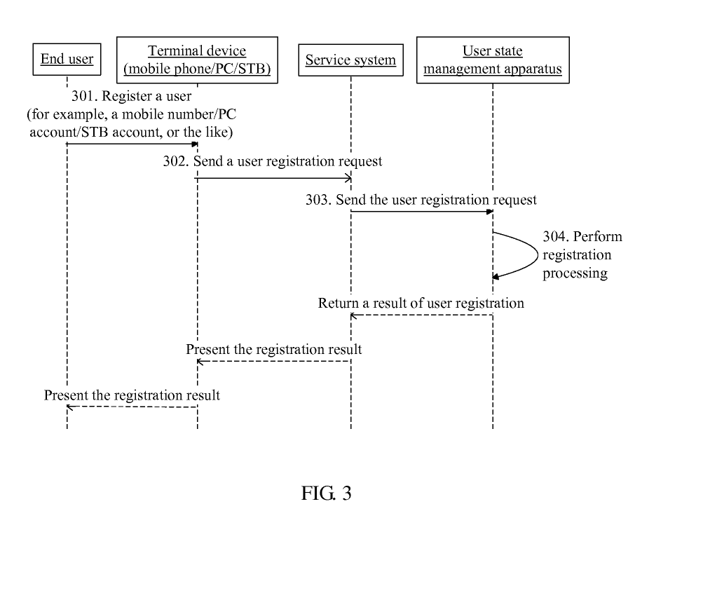

Refer to FIG. 4, which is a flowchart for changing an activation state of a user according to an embodiment of the present invention.

Step 401: The user initiates a login by entering a mobile number, a PC account, an STB account, or the like.

Steps 402 and 403: The user initiates a login request to a corresponding service system by using a terminal device; and the service system, after login authentication of the user succeeds, provides a corresponding service for the user, and initiates a user state change request, which is a login request here, to a user state management apparatus.

Step 404: The user state management apparatus records an activation state of the user, which is specifically as follows:

The state management apparatus may obtain an activation state of the user in each service system in real time, in a timely manner, or periodically. As shown in this embodiment of the present invention, a specific obtaining manner may be that, after the user logs in to or logs out of each service system, the activation state of the user in the service system is reported instantly to the user state management apparatus. For example, when the user logs in to a service system (for example, logs in to a WAP portal by using a mobile phone, logs in to a WEB portal by using a PC, or turns on an IPTV television set), the corresponding service system sends, after local account authentication is successful, a request for saving or changing the user's activation state to the user state management apparatus. In a case in which the user logs in to the service system, the user state management apparatus records an account state of the user corresponding to the service system (type) as “online” or “activated”. A procedure for logging out of the service by the user is similar to the login procedure.

In addition, for some service systems (for example, a WEB system), logout by the user may not directly trigger sending of a real-time notice to the user state management apparatus to notify that the user goes offline or has logged out. In this case, a timeout detection function may be set in the service system or the user state management apparatus, where the service system may, when determining that the online time of the user times out, send a user logout or offline request to the user state management apparatus. In addition, the user state management apparatus may also periodically receive an online notice of the user in the service system; and if the online notice is not received when the online time times out, it may also be determined and recorded that the user goes offline.

By using this embodiment of the present invention, uniform monitoring and management of an activation state of a user in various service systems can be implemented.

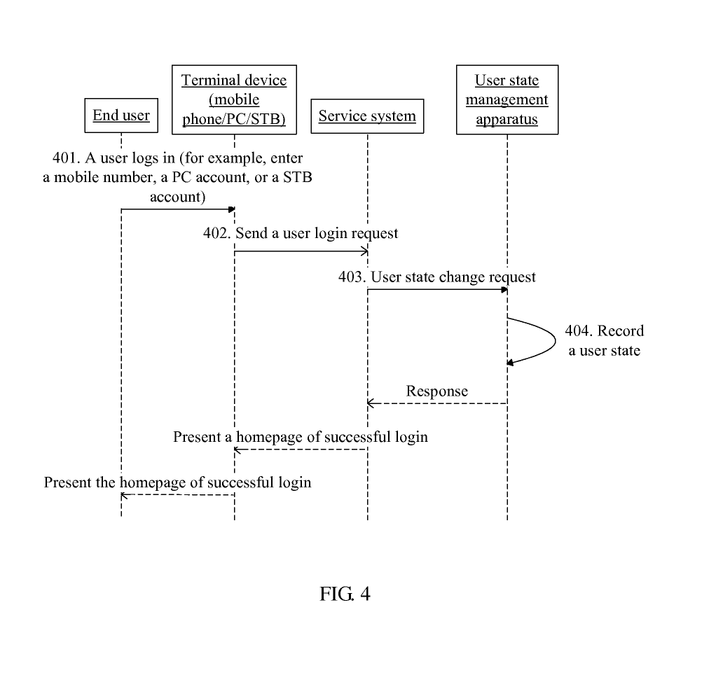

Refer to FIG. 5 which is a signaling flowchart where a user invokes a state query interface to query an activation state of another user in various service systems in a user state management apparatus.

In a service system, a condition may be preset so that in a case in which a user needs to know an online state of multiple terminal devices of another user, an interface for querying the state of multiple terminal devices of the user is first invoked to query the state of the multiple terminal devices, which is specifically as follows:

Steps 501 and 502. The user sends a request to the service system by using a terminal device to invoke the interface for querying the state of multiple terminal devices of the user, so as to query the activation state of another user in other systems according to a user identity of the other user, which is normally the user identity in the service system.

Step 503. The user state management apparatus queries, according to a stored association between user identities of the other user in various service systems and the user identity included in the state query request, the state of the multiple terminal devices of the other user, that is, the activation state of the other user in all registered service systems.

When, due to a service requirement, it is necessary for a current service system to query, through a service portal, an activity condition of a user in another service system, the service portal invokes a user state query interface of a user state management apparatus to enter a user identity, for example, an account and an account type (which may be an account in the current system or an account in the other system); and, accordingly, the user state management apparatus returns the activity condition of the user in the other service system, including an activation condition, such as online or offline.

The following describes a specific application based on a user state querying method according to this embodiment of the present invention.

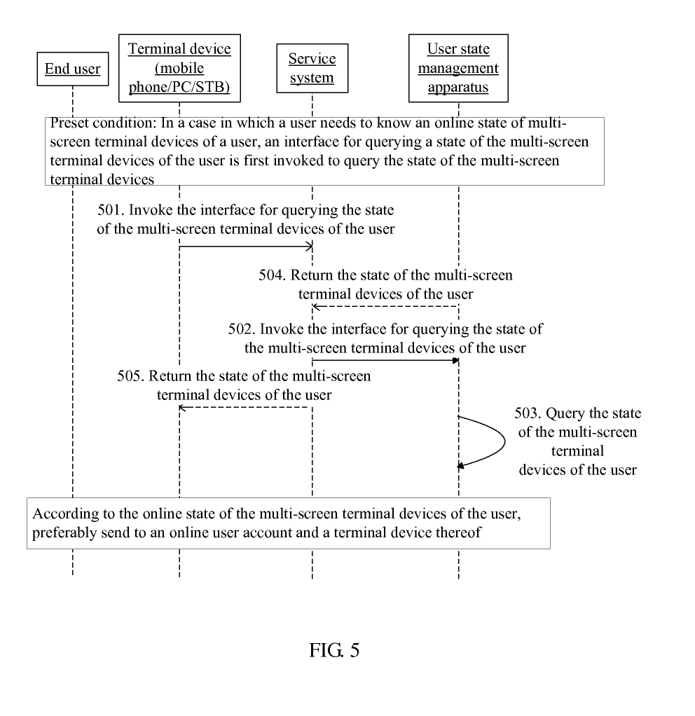

Referring to FIG. 6, this embodiment of the present invention provides an implementation method of recommending a service to a friend based on the user state querying method.

Steps B1 to B3: User B is a user who has registered a user identity in each service system with a user state management apparatus and which instantly reports an activation state in each system; in this case, the user logs in to a QQ application of an Internet service system, and the QQ application records QQ online information of the user, and sends the information to the user state management apparatus for storage; the user state management apparatus records QQ account information of user B as “online” or “activated”; user B is offline from all other registered service systems except the QQ.

Steps A1 to A7: User A learns, when watching an IPTV television by using a set-top box STB, that a latest film is already available on television; user A knows that a friend, user B, also likes the film, and therefore wants to notify the friend user B; user A queries a current state of user B by using a current IPTV system; and an IPTV portal invokes a user state query interface of the user state management apparatus to obtain activation conditions of various accounts of user B, that is, activation conditions of user B in various service systems, and finds that only the QQ account is online

Step A8 to A11: User A recommends the current film to the QQ account of user B (which is implemented by using the IPTV system); user B receives, in QQ, a recommendation message of user A, where the message may carry a uniform resource locator URL of a PC version of the film (which may be implemented by using the IPTV system); and user B may, after a click, watch the film recommended by user A on a PC.

By using the embodiment of the present invention, a query of an activation state of different users between different service systems and recommendation of a related service across service systems can be implemented.

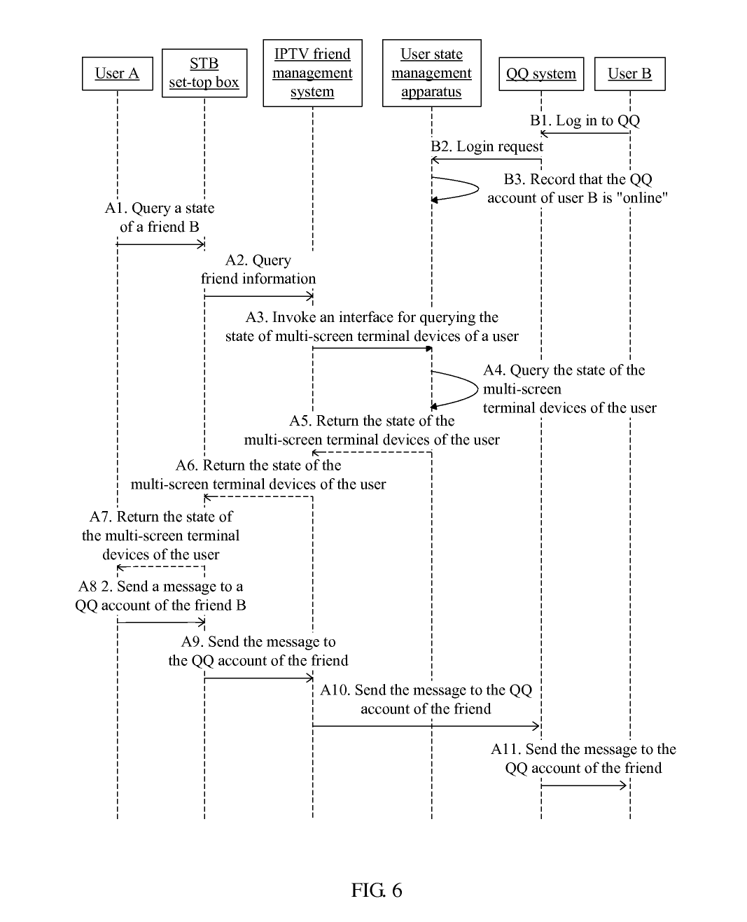

Referring to FIG. 7, the user state querying method in this embodiments of the present invention may further be used to implement intelligent information routing across service systems. In this embodiment, an intelligent message system is set, where the intelligent message system can invoke a query interface of a user state management apparatus to obtain an online state of a user, and can select an optimal communication manner according to configuration of the user, so as to implement communication with the user, which is specifically as follows:

Step 701: User A sends a message to user B by using the intelligent message system.

Steps 702 to 707: The intelligent message system first queries the online state of the user with the user state management apparatus; and then, selects one optimal communication manner according to a routing policy (configured by an administrator or user B), and notifies user B. For example, when user B is abroad and a mobile phone is powered off, but the intelligent message system finds that user B's QQ is online, and notifies user B of the message by using the QQ account.

This embodiment of the present invention improves accuracy in sending messages and avoids random sending of messages, and further saves communications resources and avoids causing unnecessary load to a network system.

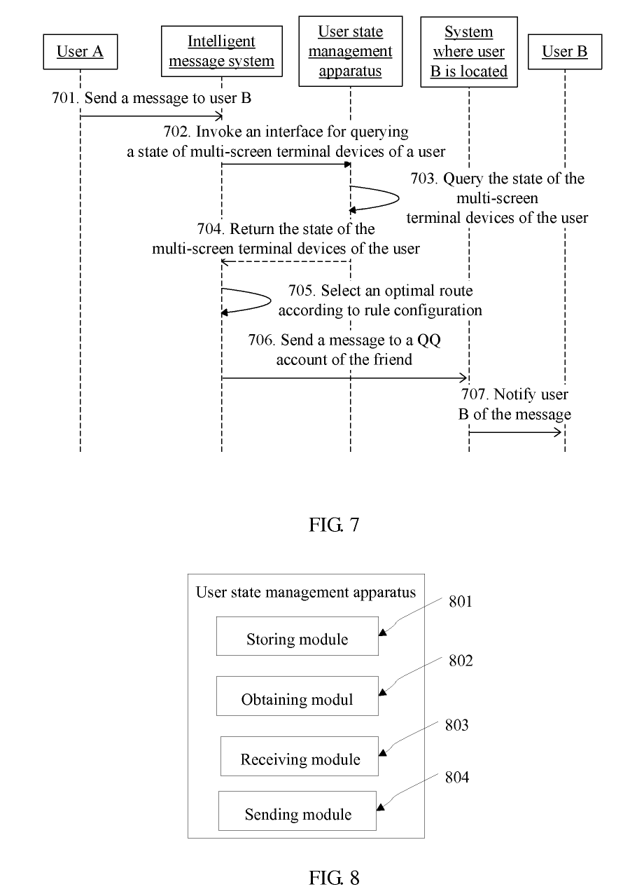

Referring to FIG. 8, an embodiment of the present invention further provides a user state management apparatus configured to execute the related user state querying method in the foregoing embodiments.

The apparatus includes a storing module 801, an obtaining module 802, a receiving module 803, and a sending module 804.

The storing module 801 is configured to save an association between a user identity of a user in a first service system and a user identity of the user in a second service system, where the first service system and the second service system are different service systems.

The obtaining module 802 is configured to obtain an activation state of the user in the first service system and the second service system.

The receiving module 803 is configured to receive a state query request from the first service system.

The sending module 804 is configured to send the activation state of the user in the second service system to the first service system according to the association and a user identity included in the state query request.

The user identity included in the state query request received by the receiving module 803 may be the user identity of the user in the first service system.

The first service system and the second service system may be any two of the following service systems:

an Internet system, a cable television system, and a mobile communications system.

The state management apparatus according to this embodiment of the present invention may implement a cross-system query of an activation state of a user between different service systems, which improves user experience.

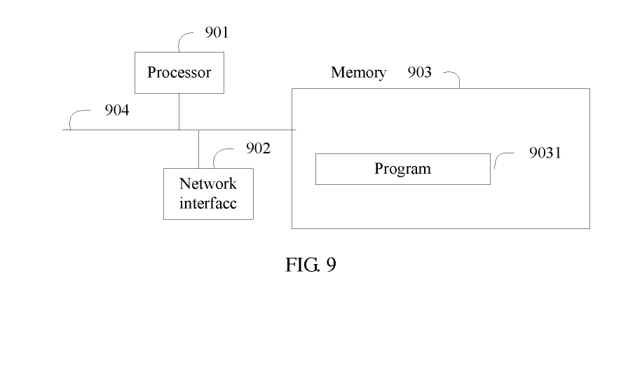

An embodiment of the present invention further provides a user state management apparatus configured to execute the related user state querying method in the foregoing embodiments. Refer to FIG. 9 which describes a structure of the user state management apparatus according to the embodiment of the present invention, which includes at least one processor 901 (for example, a CPU), at least one network interface 902 or other communications interface, a memory 903, and at least one communications bus 904 for implementing connection and communication between these apparatuses. The processor 901 is configured to execute an executable module, for example, a computer program, stored in the memory 903. The memory 903 may include a high speed random access memory (RAM: Random Access Memory), and may further include a non-volatile memory (non-volatile memory), for example, at least one magnetic disk memory. The at least one network interface 902 (which may be wired or wireless) may be configured to implement a communication connection between a system gateway and at least one other network element, where the Internet, a wide area network, a local area network, or a metropolitan area network may be used.

In some implementation manners, the memory 903 stores a program 9031, where the program 9031 may be executed by the processor 901, and the program includes:

saving an association between a user identity of a user in a first service system and a user identity of the user in a second service system, where the first service system and the second service system are different service systems;

obtaining an activation state of the user in the first service system and the second service system;

receiving a state query request from the first service system; and

sending the activation state of the user in the second service system to the first service system according to the association and a user identity included in the state query request.

The state management apparatus according to this embodiment of the present invention may implement a cross-system query of an activation state of a user between different service systems, which improves user experience.

It should be noted that, for brevity, the above method embodiments are represented as a series of actions. But those skilled in the art should appreciate that the present invention is not limited to the order of the described actions, because according to the present invention, some steps may adopt other order or occur simultaneously. It should be further understood by persons skilled in the art that the described embodiments all belong to preferred embodiments, and the involved actions and modules are not necessarily required by the present invention.

Content such as information exchange and execution procedures between all modules in the apparatus and system is based on a concept same as the method embodiments of the present invention. For the specific content, refer to the descriptions in the method embodiments of the present invention. The content is not described herein again.

Persons of ordinary skill in the art may understand that all or a part of the processes of the methods in the embodiments may be implemented by a computer program instructing relevant hardware. The program may be stored in a computer readable storage medium. When the program runs, the processes of the methods in the embodiments are performed. The storage medium may be a magnetic disk, an optical disc, a read-only memory (ROM: Read-Only Memory), or a random access memory (RAM: Random Access Memory), and the like.

Specific embodiments are used in this specification to describe the principle and implementation manners of the present invention. The foregoing embodiments are merely intended to help understand the method and idea of the present invention. In addition, with respect to the implementation manners and the application scope, modifications may be made by a person of ordinary skill in the art according to the idea of the present invention. Therefore, the specification shall not be construed as a limitation on the present invention.

1. A user state querying method, wherein the method comprises:
saving an association between a user identity of a user in a first service system and a user identity of the user in a second service system, wherein the first service system and the second service system are different service systems;
obtaining an activation state of the user in the first service system and the second service system;
receiving a state query request from the first service system; and
sending the activation state of the user in the second service system to the first service system according to the association and a user identity comprised in the state query request.

2. The user state querying method according to claim 1, wherein the user identity comprised in the state query request is the user identity of the user in the first service system.

3. The user state querying method according to claim 2, wherein:
the first service system and the second service system are any two of the following service systems:
an Internet system, a cable television system, and a mobile communications system.

4. A user state querying method, wherein the method comprises:
receiving, by a first service system, a state query request, wherein the state query request is a request for querying an activation state of a user in a second service system, the state query request comprises a user identity of the user in the first service system or the second service system, wherein the first service system and the second service system are different service systems;
sending the state query request which comprises the user identity to a user state management apparatus, wherein the user state management apparatus stores an association between the user identity of the user in the first service system and the user identity of the user in the second service system, and the activation state of the user in the first service system and the second service system; and
receiving the activation state, which is sent by the user state management apparatus, of the user in the second service system, wherein the activation state is obtained by the user state management apparatus according to the stored association and the user identity in the state query request.

5. The user state querying method according to claim 4, wherein the method further comprises:
if the user is in an activated state in the second service system, sending, by the first service system, a message to the user in the activated state in the second service system.

6. The user state querying method according to claim 5, wherein the user identity comprised in the state query request is the user identity of the user in the first service system.

7. The user state querying method according to claim 6, wherein the sending, by the first service system, a message to the user in the activated state in the second service system comprising:
the message is service recommendation information, wherein the recommendation information comprises a URL link, and an activated user in the second service system, after receiving the information, can directly trigger the URL link to access related recommended content.

8. The user state querying method according to claim 7, wherein:
the first service system and the second service system are any two of the following service systems:
an Internet system, a cable television system, and a mobile communications system.

9. A user state management apparatus, comprising:
a storing module configured to save an association between a user identity of a user in a first service system and a user identity of the user in a second service system, wherein the first service system and the second service system are different service systems;
an obtaining module is-configured to obtain an activation state of the user in the first service system and the second service system;
a receiving module is-configured to receive a state query request from the first service system; and
a sending module configured to send the activation state of the user in the second service system to the first service system according to the association and a user identity comprised in the state query request.

10. The user state management apparatus according to claim 9, wherein
the first service system and the second service system are any two of the following service systems:
an Internet system, a cable television system, and a mobile communications system.
